(19) United States
(12) Patent Application Publication
(10) Pub. No.: US 2012/0255171 A1
(43) Pub. Date: Oct. 11, 2012

(54) SYSTEMS AND METHODS FOR MANUFACTURING A PISTON

(75) Inventor: Keith Sulprizio, Carson City, NV (US)

(73) Assignee: UNITED ENGINE AND MACHINE COMPANY, Carson City, NV (US)

(21) Appl. No.: 13/080,565

(22) Filed: Apr. 5, 2011

(51) Int. Cl. B23P 15/10; B23Q 3/18

(52) U.S. Cl. 29/888.04; 269/47

(57) ABSTRACT

One example embodiment includes a system for manufacturing a piston. The system includes a holding device, where the holding device is configured to hold a piston during manufacture. The system also includes a locating ball. The locating ball is attached to the holding device and is configured to mate with a depression in the piston.

### CROSS-REFERENCE TO RELATED APPLICATIONS

Not applicable.

### BACKGROUND OF THE INVENTION

Pistons are an important component of engines, pumps and other machines. In particular, they are instrumental in ensuring that the maximum amount of force is transmitted from the combustion process to mechanical work in an engine and that mechanical work is transmitted to the fluid in a pump. Even small defects in a piston can cause inefficiencies. However, these defects are difficult to control with conventional piston manufacturing.

Piston manufacturing begins with a round bar of metal. The bar is sliced into puck shapes. The slices are then heated and pressed. The pressing can include forces of up to 500 tons. The press changes the shape of the slices, making them approximately piston shaped. The piston is then machined to the desired specifications. This machining may take as many as twenty steps to shape the different parts of the piston.

Nevertheless, this process causes a number of problems. The largest of these problems is that the high amount of pressing force can cause internal defects and stresses. These defects are virtually impossible to detect, as they require cutting to analyze the internal structure of the metal. However, these internal stresses reveal themselves during machining. For example, shaping the head of the piston can cause a stress to manifest. This stress need not manifest in the head, it can be any place in the piston. E.g., machining the head of the piston can change the size and shape of the pin hole, making previous machining processes either worthless or having to be redone.

Additionally, in the traditional the piston has to be handled by operators a large number of times. This results from the fact that many machining processes need to be done by different machines. Even when the same machine can be used, often the piston must be moved within the machine or there is an intermediate step which must be done in between the two steps. Each time the piston is handled there is a danger that other defects can be introduced. The defects can be a result of contamination or damage during the handling process.

Accordingly, there is a need in the art for a system that can reduce the number of times the piston must be handled. Further, there is a need in the art for a method which allows any internal stresses to be relieved without causing distortions.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for manufacturing a piston. The system includes a holding device, where the holding device is configured to hold a piston during manufacture. The system also includes a locating ball. The locating ball is attached to the holding device and is configured to mate with a depression in the piston.

Another example embodiment includes a system for manufacturing a piston. The system includes a first holding device. The first holding device includes a body, where the body is configured to attach to an external device, and an arm, where the arm is attached to the body. The first holding device also includes a locating ball. The locating ball is attached to the arm and is configured to mate with a first depression in the piston. The system also includes a second holding device. The second holding device includes a body, where the body is configured to attach to the external device, and an arm, where the arm is attached to the body. The second holding device also includes a locating ball. The locating ball is attached to the arm and is configured to mate with a depression in the piston. The force on the piston from the locating ball in the first holding device and the locating ball in the second holding device are sufficient to support the piston during manufacture.

Another example embodiment includes a method of manufacturing a piston. The method includes providing a first holding device, where the first holding device is configured to support a piston during manufacture, and providing a second holding device, where the second holding device is configured to support the piston during manufacture. The method also includes providing the piston, creating a first depression in the piston and creating a second depression in the piston. The method further includes placing at least a portion of the first holding device into the first depression and placing at least a portion of the second holding device into the second depression. The force on the piston from the first holding device and the second holding device are sufficient to support the piston during manufacture. The method additionally includes machining the piston, where the piston is manipulated into position using the first holding device and the second holding device.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a reciprocating engine;

FIG. 2 illustrates an example of a piston during manufacture;

FIG. 3 illustrates an example of a holding device which can be used to hold a piston during manufacture;

FIG. 4 illustrates an example of three devices used to hold the piston during manufacture of the piston; and

FIG. 5 is a flowchart illustrating an example of a method of manufacturing a piston.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

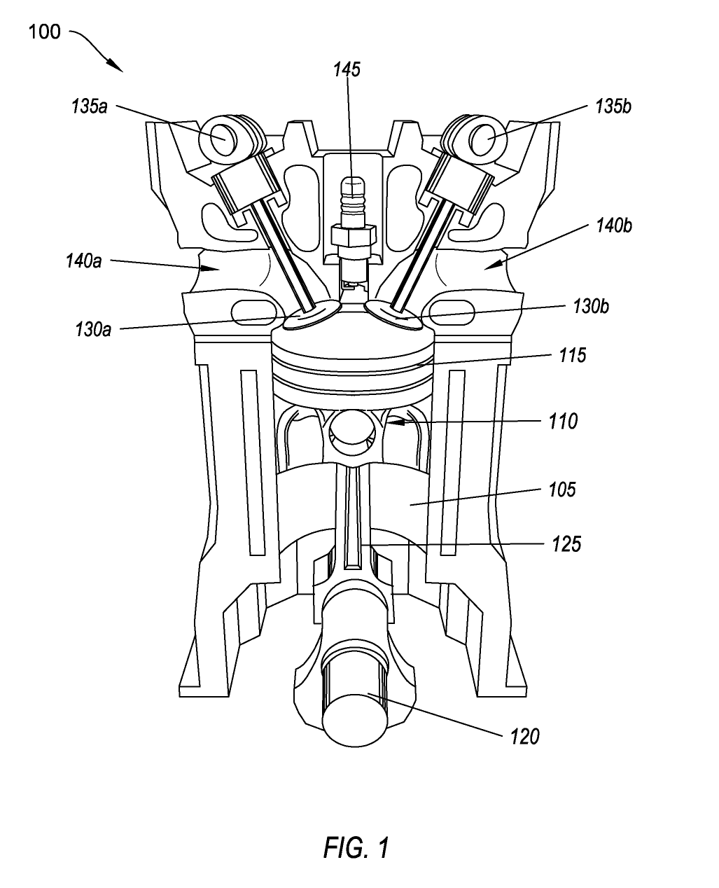

FIG. 1 illustrates an example of a reciprocating engine 100. In at least one implementation, the reciprocating engine 100 can implement embodiments of the invention, as disclosed herein. In particular, a reciprocating engine 100 is a heat engine that converts pressure, from burning fuel or other sources, into a rotating motion used to produce work. Reciprocating engines can include the internal combustion engine, the steam engine or a Stirling engine. One of skill in the art will appreciate that devices other than the reciprocating engine 100 can make use of implementations of the invention and that the reciprocating engine 100 is treated as exemplary, and not limiting, herein.

FIG. 1 shows that the reciprocating engine 100 can include a cylinder 105. In at least one implementation, the cylinder 105 is a chamber into which a gas is introduced, either already hot and under pressure (e.g., in a steam engine), or heated inside the cylinder 105 either by ignition of a fuel air mixture (e.g., in an internal combustion engine) or by contact with a hot heat exchanger in the cylinder 105 (e.g., in a Stirling engine). The hot gases can expand within the cylinder 105, with the energy of expansion converted into work, as described below.

FIG. 1 also shows that the reciprocating engine 100 can include a piston 110. In at least one implementation, the piston 110 can includes a solid piece of material tightly fitting and moving within the cylinder 105. The piston 110 can convert the energy produced by the gas expanding within the cylinder 105 into linear motion, which can be used to perform work, as described below. One of skill in the art will appreciate that in other applications, the function of the piston 110 can be reversed and force can be imparted to the piston 110 for the purpose of compressing or ejecting the fluid in the cylinder 105. Additionally or alternatively, the piston 110 also acts as a valve by covering and uncovering ports in the cylinder 105 wall.

One of skill in the art will appreciate that the reciprocating engine 100 can include more than one cylinder 105, each of which contains a piston 110. In general, the more cylinders 105 a reciprocating engine has, the more vibration-free (smoothly) it can operate. The power of a reciprocating engine can be proportional to the volume of the combined displacement of the pistons 110. In some implementations, the piston 110 may be powered in both directions in the cylinder 105 in which case it is said to be double acting. In the reciprocating engine 100 the cylinders 105 may be aligned in line, in a V configuration, horizontally opposite each other, or radially. Opposed-piston 110 engines can put two pistons 110 working at opposite ends of the same cylinder 105 and this has been extended into triangular arrangements such as the Napier Deltic.

It is common for such reciprocating engines 100 to be classified by the number and alignment of cylinders and the total volume of displacement of gas by the pistons 110 moving in the cylinders usually measured in cubic centimeters (cm³ or cc) or liters (I or L). For example, for internal combustion engines, single and two-cylinder designs are common in smaller vehicles such as motorcycles, while automobiles typically have between four and eight cylinders, and locomotives, and ships may have a dozen cylinders or more. Cylinder 105 capacities may range from 10 cm³ or less in model engines up to several thousand cubic centimeters in a ship's engines.

FIG. 1 further shows that the reciprocating engine 100 can include one or more piston rings 115. In at least one implementation, the piston rings 115 can provide an airtight seal between the sliding piston 110 and the walls of the cylinder 105 so that the high pressure gas above the piston 110 does not leak past it and reduce the efficiency of the reciprocating engine 100. I.e., a better seal between the piston rings 115 and the cylinder 105 can equal higher engine output with reduced emissions and increase engine longevity due to reduced wear and reduced engine lubrication contamination. However, minor distortions in the piston can have a large effect on the seal between the piston rings 115 and the cylinder 105. The piston rings 115 can include hard metal rings which are sprung into a circular groove in the head of piston 110.

FIG. 1 additionally shows that the reciprocating engine 100 can include a crankshaft 120. In at least one implementation, the crankshaft 120, sometimes abbreviated to crank, is the part of an engine which translates reciprocating linear motion of the piston 110 into rotation. I.e., the linear back-and-forth motion of the piston 110 is converted into rotation of the crankshaft 120. The crankshaft 120 can be connected to a flywheel, to reduce the pulsation characteristic piston 110 movement, and sometimes a torsional or vibrational damper at the opposite end, to reduce the torsion vibrations often caused along the length of the crankshaft by the cylinders farthest from the output end acting on the torsional elasticity of the metal.

FIG. 1 also shows that the reciprocating engine 100 can include a connecting rod 125. In at least one implementation, the connecting rod 125 can connect the piston 110 to the crankshaft 120. For example, it can impart the linear force of the piston 110 to the crankshaft 120. Additionally or alternatively, the connecting rod 125 can convert rotating motion from the crankshaft 120 into linear motion of the piston 110. To convert the reciprocating motion into rotation, the crankshaft 120 can include crank throws, also called crankpins, or other bearing surfaces whose axis is offset from that of the crankshaft 120 and to which the connecting rod 125 can be connected. In at least one implementation, the connecting rod 125 can be rigid in order to transmit either a push or a pull from the piston 110 and so the connecting rod 125 can rotate the crankshaft 120 through both halves of a revolution.

FIG. 1 further shows that the reciprocating engine 100 can include a first valve 130a and a second valve 130b (collectively “valves 130”). In at least one implementation, the valves 130 can control the flow of gases into or out of the cylinder 105. In particular, the valves 130 can be biased into the open position using a spring or some other mechanism and can be closed when necessary.

FIG. 1 additionally shows that reciprocating engine 100 can include a first camshaft 135a and a second camshaft 135b (collectively “camshafts 135”). In at least one implementation, the camshaft 135 can include a shaft which includes a disk or cylinder having an irregular form such that its motion, usually rotary, gives to a part or parts in contact with it a specific rocking or reciprocating motion. In particular, the first camshaft 135a and the second camshaft 135b can rotate, providing regular intervals at which the first valves 130a and the second valve 130b respectively, are opened and closed.

FIG. 1 also shows that the reciprocating engine 100 can include an intake port 140a and an exhaust port 140b (collectively “ports 140”). In at least one implementation, the intake port 140a can be used to allow fuel, air or a fuel/air mixture into the cylinder 105, where it will expand to drive the piston 110 and the exhaust port 140b can allow waste gases to exit the cylinder 105.

FIG. 1 further shows that the reciprocating engine 100 can include a spark plug 145. In at least one implementation, a spark plug 145 is an electrical device that fits into the cylinder 105 and ignites the fuel/air mixture by means of an electric spark. In particular, the spark plug 145 can include an insulated central electrode which is connected by a heavily insulated wire to an ignition coil or magneto circuit on the outside, forming, with a grounded terminal on the base of the plug, a spark gap inside the cylinder 105.

By way of example to show the operation of the reciprocating engine 100, in a 4-stroke engine, the first camshaft 135a can open the first valve 130a when the piston 110 is near the top of the cylinder 105. As the piston 110 moves toward the bottom of the cylinder 105 the movement can “pull” a fuel/air mixture into the cylinder 105. The first valve 130a can be closed and as the piston 110a moves toward the top of the cylinder 105, the fuel/air mixture is compressed. The sparkplug 145 can then be used to ignite to fuel/air mixture. The resulting expansion can drive the piston 110 toward the bottom of the cylinder 105. The second cam shaft 135a can then open the second valve 130a and as the piston 110 moves toward the top of the cylinder 105 the exhaust gases can be pushed out of the cylinder 105 and the cycle can begin again.

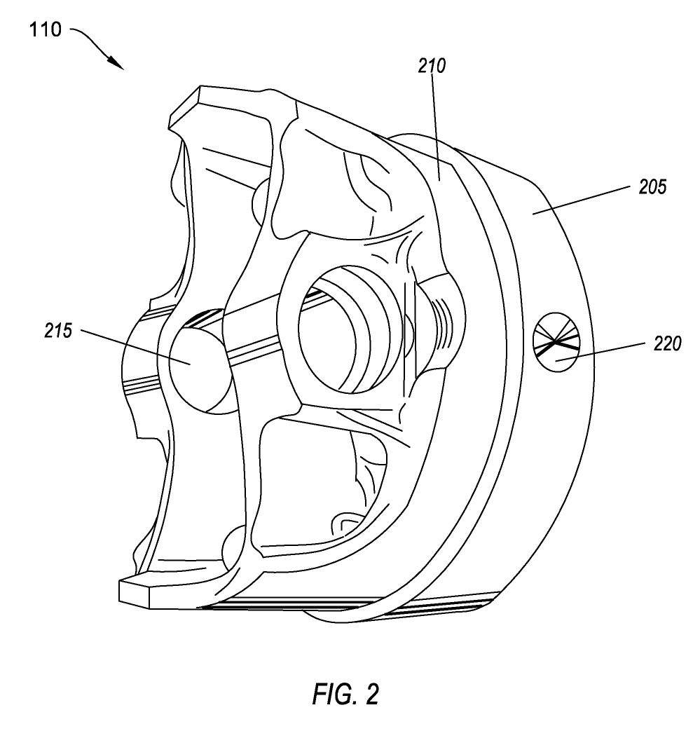

FIG. 2 illustrates an example of a piston 110 during manufacture. In at least one implementation, the piston 110 can be used in an engine, such as the reciprocating engine 100 of FIG. 1, reciprocating pumps, gas compressors, pneumatic cylinders, and other similar mechanisms. One of skill in the art will appreciate that the use of the piston 110 does not limit the claims, unless otherwise specified in the claims. The piston size and weight may need to be within small tolerances in order to ensure efficient operation. For example, the weight of the piston can includes a tolerance of as low as +/−2 grams.

FIG. 2 shows that the piston 110 can include a head 205. In at least one implementation, the head 205 is placed within a cylinder in an engine, pump or other device. In particular, the head 205 will come in contact with the gas or liquid within the cylinder. The movement of the head 205 within the cylinder can be used to compress the gas or liquid within and/or force gas or liquid from the cylinder.

FIG. 2 also shows that the piston 110 can include a body 210. In at least one implementation, the body 210 can provide support for the head 205. In particular, the piston 110 must have sufficient mass and strength to withstand the forces to which it will be subjected. However, if the piston 110 is too heavy, then it will reduce the efficiency of the engine, pump or other device. The body 210 can provide the necessary mass and provide strength to prevent damage to the head 205. The tolerance of the body 210 diameter can be +/−0.0005 inches. Additionally or alternatively, the taper of the body 210 can be +/−0.0002 inches.

FIG. 2 further shows that the piston 110 can include a pin hole 215. In at least one implementation, the pin hole can connect the piston 110 to a connecting rod and/or crank shaft. The pin hole 215 can be subjected to a large amount of force during operation. For example, in an internal combustion engine, the gas in the cylinder expands rapidly. The force of this expansion is transmitted to the connecting rod and/or crankshaft through the pin hole 215. Defects in the piston material during manufacture may cause extensive problems in the pin hole 215. In particular, material strain may cause defects that distort the pin hole 215 beyond acceptable tolerances. For instance, in order for the transmission of force to be as efficient as possible, the axis of the pin hole 215 may need to be nearly perpendicular to the major axis of the piston. For example, the major axis of the piston may need to be within 1.5 degrees of perpendicular to the pin hole 215 axis. Additionally or alternatively, the pin hole 215 can require a tight fit with the connecting rod. For example, the tolerance of the pin hole 215 diameter can be +/−0.0001 inches and the tolerance of the pin hole 215 roundness can be +/−0.0002 inches.

FIG. 2 additionally shows that the piston 110 can include one or more depressions 220. In at least one implementation, the depressions 220 can be used to aid the manufacture of the piston 110. In particular, the depressions 220 can be used to manipulate the position and/or orientation of the piston 110 during manufacture without the need for an operator to handle the piston 110. The depressions 220 can then be removed at the end of manufacture, as described below.

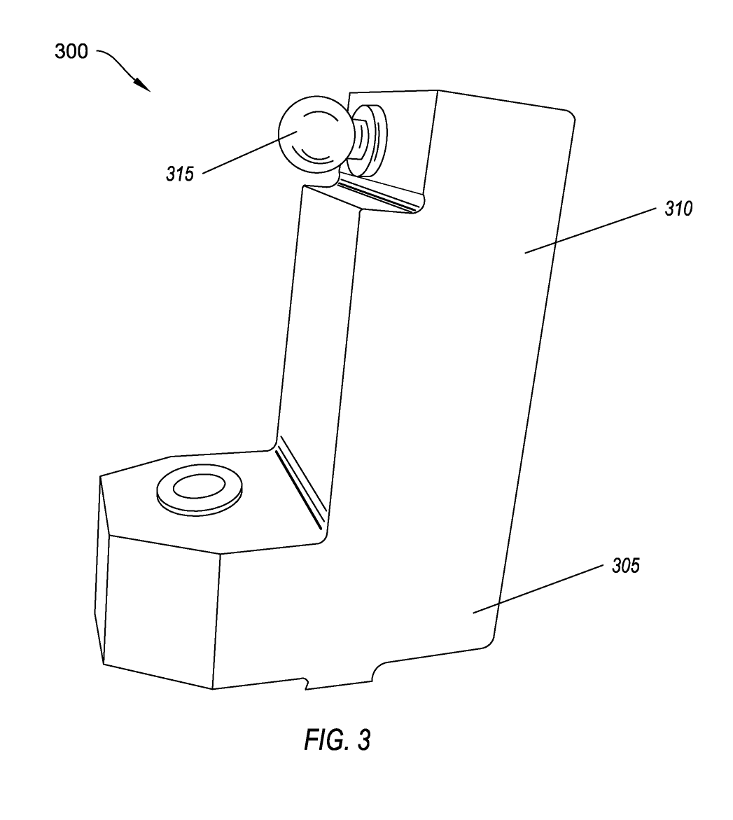

FIG. 3 illustrates an example of a holding device 300 which can be used to hold a piston during manufacture. In at least one implementation, the holding device 300 can be used to manipulate the position and/or orientation of the piston during manufacture. In particular, the holding device 300 can be used to reduce the number of times the piston must be handled by an operator during manufacture. Each time the piston is handled there is a chance that the quality can be reduced. In particular, the piston can be dropped or chipped or other contaminates, such as oils and dirt, can be introduced during handling. Further, machining processes are often done in order of convenience rather than to increase quality. For example, the piston may be left in a single machine that is capable of two machining processes even if the quality would be increased by intermediate machining processes performed by other machines.

FIG. 3 shows that the holding device 300 can include a body 305. In at least one implementation, the body 305 is configured to allow the holding device 300 to attach to an external device. In particular, the body 305 can be attached to an external device that is capable of supporting the piston and the holding device 300 during manufacture. For example, the external device can include a robotic arm capable of holding the holding device 300 and piston during manufacture. Additionally or alternatively, the external device can include the device which will machine the piston.

FIG. 3 also shows that the holding device 300 can include an arm 310. In at least one implementation the arm 310 can be attached to the body 305. In particular, the arm 310 can extend substantially perpendicular from the body 305. The arm 310 can be used to support the piston. I.e., the body 305 and the arm 310 allow the external device to manipulate the position and/or orientation of the piston. One of skill in the art will appreciate that the body 305 and the arm 310 can be a single piece of material or multiple pieces of material attached to one another.

FIG. 3 further shows that the holding device 300 can include a locating ball 315. In at least one implementation, the locating ball 315 can be attached the arm 310. The locating ball 315 can be configured to mate with a depression in the piston. In particular, the locating ball 315 can be pressed into the depression. Forces of locating balls 315 in two, three or more depressions can establish contact which is used to manipulate the position of the piston.

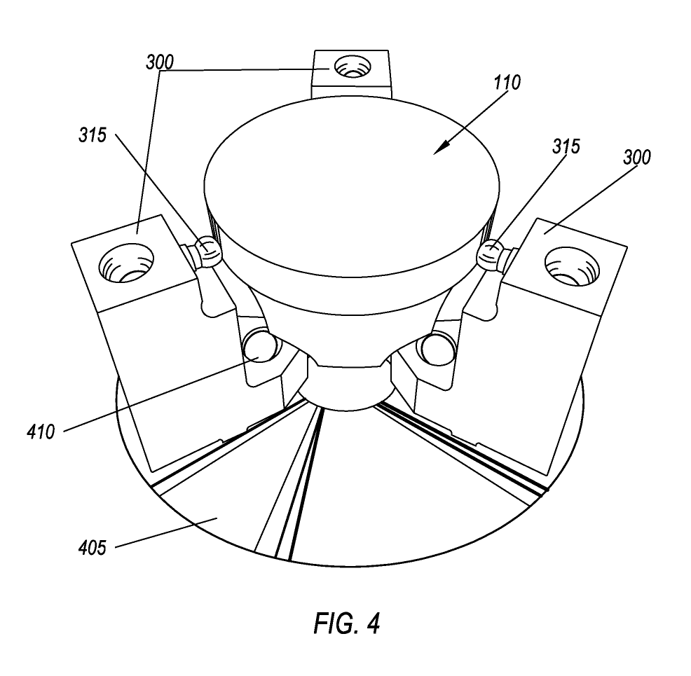

FIG. 4 illustrates an example of three devices 300 used to hold a piston 110 during manufacture of the piston 110. In at least one implementation, the three devices 300 provide three points of contact, via the three locating balls 315, on the piston 110. The three points form a plane which controls both the position and the orientation of the piston 110.

One of skill in the art will appreciate that the locating balls 315 need not be placed on or near the head 205 of the piston 110. I.e., depressions in the piston 110 can be at any location on the piston 110. For example, the depressions can be located on the body of the piston 110 or near the pinhole. One of skill in the art will further appreciate that the contact point between the locating balls 315 and the piston 110 need not remain constant throughout the machining process. I.e., the depressions can be machined into various parts of the piston 110 to allow more changes in the area to be machined.

FIG. 4 shows that the three devices 300 can be attached to the manufacturing machine 405. In at least one implementation, the manufacturing machine 405 can be used to machine the piston 110. In particular, the manufacturing machine 405 can be used to remove or reshape portions of the piston 110. For example, the manufacturing machine 405 can be used to drill the pin hole, produce the rings configured to receive the piston rings and/or remove outer layers or other excess material in the piston 110.

FIG. 4 shows that the devices can include a connector 410. In at least one implementation, the connector 410 is configured to releasably attach the devices 300 to the manufacturing machine 405. The connector 410 can include any device or apparatus configured to attach the devices to the manufacturing machine. For example, the connector 410 can include screws, bolts, clamps or any other connecting device. Additionally or alternatively, the connector 410 can include a chuck. In at least one implementation, the chuck can include a cylindrical clamp that can be used to secure some portion of the manufacturing machine 405 or the devices 300.

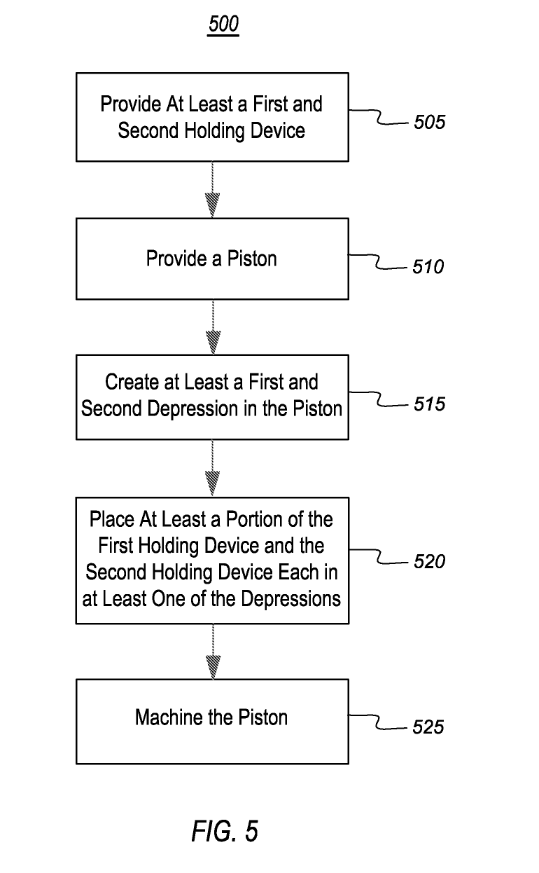

FIG. 5 is a flowchart illustrating an example of a method 500 of manufacturing a piston. In at least one implementation, the method 500 can allow for higher quality control than conventional methods. In particular, the method 500 can reduce the number of times that the piston is handled. One of skill in the art will appreciate that the method 500 can be used to produce the piston 110 of FIG. 1; however, the method 500 can be used to produce a piston other than the piston 110 of FIG. 1.

FIG. 5 shows that the method 500 can include providing at least a first and second holding device 505. In at least one implementation, the holding device can be used to manipulate the position and/or orientation of the piston during manufacture. In particular, the holding device can be used to reduce the number of times the piston must be handled by an operator during manufacture. Each time the piston is handled there is a chance that the quality can be reduced. In particular, the piston can be dropped or chipped or other contaminates, such as oils and dirt, can be introduced during handling. Further, machining processes are often done in order of convenience rather than to increase quality. For example, the piston may be left in a single machine that is capable of two machining processes even if the quality would be increased by intermediate machining processes performed by other machines.

In at least one implementation, the holding device can include a body. The body can be configured to allow the holding device to attach to an external device. In particular, the body can be attached to an external device that is capable of supporting the piston and the holding device during manufacture. For example, the external device can include a robotic arm capable of holding the holding device and piston during manufacture. Additionally or alternatively, the external device can include the device which will machine the piston.

In at least one implementation, the holding device can include an arm. The arm can be attached to the body. In particular, the arm can extend substantially perpendicular from the body. The arm can be used to support the piston. I.e., the body and the arm allow the external device to manipulate the position and/or orientation of the piston. One of skill in the art will appreciate that the body and the arm can be a single piece of material or multiple pieces of material attached to one another. In at least one implementation, the holding device can include a locating ball attached the arm.

FIG. 5 shows that the method 500 can also include providing a piston 510. In at least one implementation, the piston can include a piston blank. In particular, the piston blank is a cylindrical piece of material. The piston blank is then pressed into the approximate shape of the piston. However, the piston blank requires further machining before it can be used. Additionally or alternatively, the piston can include a piston that has been partially machined. I.e., the method 500 can be used to finish a piston on which machining has already begun. The piston can be used in an engine, such as the reciprocating engine 100 of FIG. 1, reciprocating pumps, gas compressors, pneumatic cylinders, and other similar mechanisms. One of skill in the art will appreciate that the use of the piston does not limit the claims, unless otherwise specified in the claims.

In at least one implementation, the piston can include a head. The head is placed within a cylinder in an engine, pump or other device. In particular, the head will come in contact with the gas or liquid within the cylinder. The movement of the head within the cylinder can be used to compress the gas or liquid within and/or force gas or liquid from the cylinder.

In at least one implementation, the piston can include a body. The body can provide support for the head. In particular, the piston must have sufficient mass and strength to withstand the forces to which it will be subjected. However, if the piston is too heavy, then it will reduce the efficiency of the engine, pump or other device. The body can provide the necessary mass and provide strength to prevent damage to the head.

In at least one implementation, the piston can include a pin hole. The pin hole can connect the piston to a connecting rod and/or crank shaft. The pin hole can be subjected to a large amount of force during operation. For example, in an internal combustion engine, the gas in the cylinder expands rapidly. The force of this expansion is transmitted to the connecting rod and/or crankshaft through the pin hole. Additionally or alternatively, the pin hole can require a tight fit with the connecting rod.

FIG. 5 further shows that the method 500 can include providing at least a first and second depression in the piston 515. One of skill in the art will appreciate that the number of depressions can match the number of holding devices. In at least one implementation, the depressions can be used to aid the manufacture of the piston. In particular, the depressions can be used to manipulate the position and/or orientation of the piston during manufacture without the need for an operator to handle the piston. The depressions can then be removed at the end of manufacture, as described below.

FIG. 5 additionally shows that the method 500 can include placing at least a portion of the first holding device and the second holding device each in at least one of the depressions 520. In particular, the locating ball attached to the arm can be pressed into the depression. Forces of locating balls in two, three or more depressions can establish contact which is used to manipulate the position of the piston. The three points form a plane which controls both the position and the orientation of the piston.

One of skill in the art will appreciate that the locating balls can be placed anywhere on the piston. For example, the depressions can be located on the head of the piston. Additionally or alternatively, the depressions can be located on the body of the piston or near the pinhole. One of skill in the art will further appreciate that the contact point between the locating balls and the piston need not remain constant throughout the machining process. I.e., the depressions can be machined into various parts of the piston to allow more changes in the area to be machined.

FIG. 5 also shows that the method 500 can include machining the piston 525. In at least one implementation, machining the piston 525 can include removing excess materials from the piston. For instance, the material can be removed via drilling, cutting or shaving off the extra materials. For example, drilling the pin hole, producing the rings configured to receive the piston rings and/or removing outer layers or other excess material in the piston.

In at least one implementation, the method 500 can also include removing the depressions from the piston. For example, the exterior layers of the piston can be removed to at least the depth of the depressions. I.e., the depressions can be created in material that will eventually be removed from the piston.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for manufacturing a piston, the system comprising:
a holding device, wherein the holding device is configured to hold a piston during manufacture;
a locating ball, wherein the locating ball:
is attached to the holding device; and
is configured to mate with a depression in the piston.

2. The system of claim 1, wherein the holding device includes:
a body, wherein the body is configured to attach to an external device.

3. The system of claim 2, wherein the holding device includes:
a first arm extending from the body, wherein the locating ball is attached to the first arm.

4. The system of claim 3, wherein the first arm is substantially perpendicular to the body.

5. The system of claim 3, wherein the holding device includes:
a second arm extending from the body; and
a second locating ball, wherein second locating ball is attached to the second arm.

6. The system of claim 5, wherein the second arm is substantially parallel to the first arm.

7. The system of claim 6, wherein the holding device includes:
a third arm extending from the body; and
a third locating ball, wherein third locating ball is attached to the third arm.

8. A system for manufacturing a piston, the system comprising:
a first holding device, wherein the first holding device includes:
a body, wherein the body is configured to attach to an external device;
an arm, wherein the arm is attached to the body;
a locating ball, wherein the locating ball:
is attached to the arm; and
is configured to mate with a first depression in a piston; and
a second holding device, wherein the first holding device includes:
a body, wherein the body is configured to attach to the external device;
an arm, wherein the arm is attached to the body;
a locating ball, wherein the locating ball:
is attached to the arm; and
is configured to mate with a second depression in the piston;
wherein the force on the piston from the locating ball in the first holding device and the locating ball in the second holding device are sufficient to support the piston during manufacture.

9. The system of claim 8 further comprising a first chuck, wherein the first chuck is configured to attach the first holding device to the external device.

10. The system of claim 9 further comprising a second chuck, wherein the second chuck is configured to attach the second holding device to the external device.

11. The system of claim 8, wherein the external device is a robotic arm, wherein the robotic arm is configured to manipulate the position and orientation of the piston during manufacture.

12. The system of claim 8 further comprising:
a third holding device, wherein the third holding device includes:
a body, wherein the body is configured to attach to the external device;
an arm, wherein the arm is attached to the body; and
a locating ball, wherein the locating ball:
is attached to the arm; and
is configured to mate with a third depression in the piston.

13. A method of manufacturing a piston, the method comprising:
providing a first holding device, wherein the first holding device is configured to support a piston during manufacture;
providing a second holding device, wherein the second holding device is configured to support the piston during manufacture;
providing the piston;
creating a first depression in the piston;
creating a second depression in the piston;
placing at least a portion of the first holding device into the first depression;
placing at least a portion of the second holding device into the second depression;
wherein the force on the piston from the first holding device and the second holding device are sufficient to support the piston during manufacture; and
machining the piston, wherein the piston is manipulated into position using the first holding device and the second holding device.

14. The method of claim 13 wherein machining the piston includes removing excess materials from the piston.

15. The method of claim 13, wherein the first holding device includes a first locating ball, wherein the locating ball is configured to mate with the first depression.

16. The method of claim 13, wherein the second holding device includes a second locating ball, wherein the second locating ball is configured to mate with the second depression.

17. The method of claim 13, wherein the first depression and the second depression are in the head of the piston.

18. The method of claim 13, wherein the first depression and the second depression are in the body of the piston.

19. The method of claim 13 further comprising removing the first depression and the second depression from the piston.

20. The method of claim 13, wherein removing the first depression and the second depression from the piston includes removing exterior layers of the piston to at least the depth of the first depression and the second depression.
